(19) United States
(12) Patent Application Publication
(10) Pub. No.: US 2018/0229743 A1
(43) Pub. Date: Aug. 16, 2018

(54) AUTOMATED DRIVING ASSISTANCE APPARATUS, AUTOMATED DRIVING ASSISTANCE SYSTEM, AUTOMATED DRIVING ASSISTANCE METHOD, PROGRAM, AND RECORDING MEDIUM

(71) Applicant: OMRON Corporation, Kyoto-shi (JP)

(72) Inventor: Hatsumi AOI, Kyotanabe-shi (JP)

(73) Assignee: OMRON Corporation, Kyoto-shi (JP)

(21) Appl. No.: 15/956,013

(22) Filed: Apr. 18, 2018

Related U.S. Application Data
(63) Continuation of application No. PCT/JP2016/082295, filed on Oct. 31, 2016.

(30) Foreign Application Priority Data
Nov. 20, 2015 (JP) 2015-227327

(51) Int. Cl. B60W 50/16; G05D 1/00; B60K 28/02; B60W 40/08; G05D 1/02

(52) U.S. Cl. CPC B60W 50/16; G05D 1/0061; G05D 1/0088; B60W 2040/0818; B60W 40/08; G05D 1/0212; B60K 28/02

(57) ABSTRACT

An automated driving assistance apparatus is an automated driving assistance apparatus for assisting automated driving of a passenger car, and includes a position detection unit and a notification control unit. The position detection unit detects a checkpoint that is before, in the advancing direction, a switching zone in which a switch is made from automated driving to manual driving. When the position detection unit detects that the vehicle has reached the checkpoint, the notification control unit controls a notification unit to notify the driver of preparation items required for manual driving when switching from automated driving to manual driving.

### CROSS REFERENCE TO RELATED APPLICATIONS

This application is a continuation application of International Application No. PCT/JP2016/082295, filed on Oct. 31, 2016, which claims priority based on the Article 8 of Patent Cooperation Treaty from prior Japanese Patent Application No. 2015-227327, filed on Nov. 20, 2015, the entire contents of which are incorporated herein by reference.

### TECHNICAL FIELD

The disclosure relates to an automated driving assistance apparatus, an automated driving assistance system, an automated driving assistance method, a program and a recording medium for assisting automated driving of a vehicle.

### RELATED ART

In recent years, for example, automated driving techniques for performing automated driving of a vehicle on a roadway such as a highway have been suggested. Regarding automated driving techniques, the National Highway Traffic Safety Administration (NHTSA) of the U.S. Department of Transportation has set four automated driving levels including Level 4 at which fully-automated traveling is possible.

Among these driving levels, Level 3 that is set as a semi-automated traveling system is defined as a state where accelerating, steering, and braking are all performed by the system, and when the system makes a request, the driver responds to the request. Therefore, in the system of Level 3, it is important for the driver to promptly cope with manual driving when switching from automated driving to manual driving.

For example, Patent Document 1 discloses an automated driving assistance apparatus for a vehicle that smoothly makes a switch from automated driving to manual driving by setting a relay point before an area in which vehicles can stop, in an automated driving zone.

### RELATED ART DOCUMENTS

### Patent Documents

### Patent Document 1: JP 2008-290680A

### SUMMARY OF THE INVENTION

### Problem to be Solved by the Invention

However, in the above-described conventional automated driving assistance apparatus, preparations by the driver when switching from automated driving to manual driving are not taken into consideration, and thus there is a problem as described below.

In the automated driving assistance apparatus of Patent Document 1, a switch is made to manual driving when the driver is awake, and when it is detected that the driver is taking a nap, it is determined that a switch to manual driving cannot be made, and the vehicle is stopped in a parking area, a service area, or the like without exception.

However, even when the driver is awake, since the driver is not involved in the driving operation during automated driving, there are cases where the driver is not prepared for driving when a switch is made from automated driving to manual driving and has difficultly promptly coping with manual driving.

One or more aspects may provide an automated driving assistance apparatus, an automated driving assistance system, an automated driving assistance method, a program, and a recording medium that enable the driver to promptly cope with manual driving when switching from automated driving to manual driving.

### Means for Solving the Problems

An automated driving assistance apparatus according to a first aspect is an automated driving assistance apparatus for assisting automated driving of a vehicle, and includes a first position detection unit and a notification control unit. The first position detection unit detects a first position that is before, in an advancing direction, a switching zone in which a switch is made from the automated driving to manual driving. When the first position detection unit detects that the vehicle has reached the first position, the notification control unit controls a notification unit to notify a driver of a preparation item required for manual driving when switching from the automated driving to the manual driving.

In this manner, it is possible to notify the driver of the preparation item required for manual driving before the vehicle reaches the switching zone in which a switch is made from automated driving to manual driving.

Therefore, the driver can prepare, in advance, the preparation item required during manual driving, before a switch is made from automated driving to manual driving. Accordingly, even if the driver is not involved in the driving operation during automated driving, the driver can make preparations before the switch due to support of the automated driving assistance apparatus, and thus can promptly cope with manual driving.

In addition, the switching zone in which a switch is made from automated driving to manual driving refers to, for example, in a case where a vehicle is traveling on a highway, a zone that is automatically set at a position that is several kilometers before the exit of the interchange closest to the destination. Alternatively, in the case where information regarding traffic congestion or an accident is obtained while a vehicle is traveling, the switching zone may be a zone that is automatically set at a position that is several kilometers before the traffic congestion zone.

An automated driving assistance apparatus according to a second aspect is the automated driving assistance apparatus according to a first aspect, and further includes a switching control unit. The switching control unit performs control regarding a switch from the automated driving to the manual driving in the switching zone, based on detection by an implementation checking unit that checks whether or not the preparation item has been implemented.

Accordingly, it is possible to determine whether or not to switch from automated driving to manual driving, based on a result of the check performed by the implementation checking unit.

Specifically, in the case where the preparation item has been implemented, a switch can be made from automated driving to manual driving in the switching zone. In the case where the preparation item has not been implemented, control can be performed so as to not make a switch from automated driving to manual driving in the switching zone. In this manner, if the preparation item has not been implemented, safety can be secured by continuing automated driving.

Note that implementation may be automatically checked by the implementation checking unit using a sensor or the like, or if the preparation item is displayed on a display such as a touch panel, the driver may confirm that the preparation item has been implemented, by touching the touch panel. In addition, confirmation by the driver may be made through an audible response, a gesture, or the like.

An automated driving assistance apparatus according to a third aspect is the automated driving assistance apparatus according to a second aspect, and further includes a second position detection unit. The second position detection unit detects a second position provided between the first position and the switching zone. In the case where the implementation checking unit has not confirmed that the preparation item has been implemented when the second position detection unit detects that the vehicle has reached the second position, the switching control unit does not make a switch from the automated driving to the manual driving.

In this manner, if the preparation item has not been implemented when the second position provided before the switching zone in which a switch is made from automated driving to manual driving is reached, control can be performed so as to not make a switch to manual driving.

Therefore, in the case where the preparation item has not been implemented, automated driving can be continued, and safety can be secured.

An automated driving assistance apparatus according to a fourth aspect is the automated driving assistance apparatus according to a third aspect, and further includes an automatic stop control unit. In the case where the implementation checking unit has not confirmed that the preparation item has been implemented when the second position detection unit detects that the vehicle has reached the second position, the automatic stop control unit automatically stops the vehicle in a shelter area.

Accordingly, in the case where the preparation item required for performing manual driving has not been implemented when a vehicle reaches the second position provided before the switching zone in which a switch is made from automated driving to manual driving, the vehicle can be automatically stopped in a shelter area.

Here, the shelter area refers to an area in which safety can be secured even when a vehicle is stopped, such as a roadside station, a side strip, a parking area or a service area of a highway, or the like.

Therefore, in the case where the preparation item has not been implemented, the vehicle can be stopped through automated driving, and safety can be secured.

An automated driving assistance apparatus according to a fifth aspect is the automated driving assistance apparatus according to a first aspect, and the notification unit is a display or a speaker.

Accordingly, the driver can be informed of the preparation item required for manual driving, using the display or speaker. In the case of a display, the preparation item is displayed. In the case of a speaker, preparation items are read out in order. Note that the display or speaker of a navigation apparatus mounted in the vehicle may be used as the display or speaker, for example.

An automated driving assistance apparatus according to a sixth aspect is the automated driving assistance apparatus according to a first aspect, and the preparation items include wearing of shoes, a forward facing sitting posture, seat position adjustment, wearing of a seat belt, position adjustment of a side mirror or a rearview mirror, holding of a steering wheel, placing of a foot on an accelerator pedal, or a check of a surrounding vehicle situation.

By checking these preparation items, manual driving can be coped with promptly.

Note that, in the case where implementation of the preparation items is automatically checked using a sensor or the like, wearing of shoes may be checked using an image, or an infrared sensor or the like, and a forward facing sitting posture may be checked based on an image. In addition, seat position adjustment may be checked using an image, or may be checked by providing a sensor (a position sensor, an encoder, or a linear sensor) or the like. Wearing of a seat belt has been detected in vehicles in recent years, and thus can be checked by receiving a signal of such detection, or may be checked based on an image. The side mirror being open can be checked by receiving a signal from an opening/closing mechanism, which has been provided in vehicles in recent years. A rearview mirror being positioned appropriately may be checked using an image, or may be checked by providing a sensor (a position sensor or an encoder) or the like. Holding of a steering wheel may be checked using a pressure sensor, or an image may be used to check whether or not the steering wheel is being held. Placing of a foot on an accelerator pedal may be checked using an image, or may be checked by providing a sensor (a pressure sensor or a position sensor).

In addition, in the case of checking that is based on an image, rather than only performing the checking using the current image that has been captured, learning may be performed in advance based on an image showing a state where a preparation item has been implemented and an image showing a state where the preparation item has not been implemented, and implementation (of the preparation item) may be performed using the current image, based on the learning result.

An automated driving assistance apparatus according to a seventh aspect is the automated driving assistance apparatus according to a second aspect, and the implementation checking unit includes a camera or a sensor. Accordingly, a preparation item whose implementation can be checked using a camera can be checked automatically.

In addition, the sensor is a pressure sensor, an infrared sensor, a position sensor (a linear sensor, an encoder, or a potentiometer) or the like, and a preparation item whose implementation can be checked using a sensor can be checked automatically.

An automated driving assistance system according to an eighth aspect is an automated driving assistance system for assisting automated driving of a vehicle, and includes a first position detection unit, a notification unit, and a notification control unit. The first position detection unit detects a first position that is before, in an advancing direction, a switching zone in which a switch is made from the automated driving to manual driving. The notification unit notifies a driver of a preparation item required for manual driving when switching from the automated driving to the manual driving. The notification control unit controls the notification unit to perform the notification when the first position detection unit detects that the vehicle has reached the first position.

Accordingly, even if the driver is not involved in the driving operation during automated driving, the driver can make preparations for manual driving before the switch from automated driving to manual driving, and thus can promptly cope with manual driving.

An automated driving assistance method according to a ninth aspect is an automated driving assistance method for assisting automated driving of a vehicle, and includes detecting and notifying. In the detecting, a first position that is before, in an advancing direction, a switching zone in which a switch is made from the automated driving to manual driving is detected. In the notifying, when it is detected in the detecting that the vehicle has reached the first position, a driver is notified of a preparation item required for manual driving when switching from the automated driving to the manual driving.

Accordingly, even if the driver is not involved in the driving operation during automated driving, the driver can prepare for manual driving before switching from automated driving to manual driving, and thus can promptly cope with manual driving.

A program according to a tenth aspect is a program for assisting automated driving of a vehicle, and causes a computer to execute detecting and notifying. In the detecting, a first position that is before, in an advancing direction, a switching zone in which a switch is made from the automated driving to manual driving is detected. In the notifying, when it is detected in the detecting that the vehicle has reached the first position, a driver is notified of a preparation item required for manual driving when switching from the automated driving to the manual driving.

By executing this program, even if the driver is not involved in the driving operation during automated driving, the driver can prepare for manual driving before switching from automated driving to manual driving, and thus can promptly cope with manual driving.

A recording medium according to an eleventh aspect is a recording medium that stores the program of a tenth aspect, and is processable by a computer.

In this manner, the above program may be stored on the recording medium that is processable by a computer.

### Effects of the Invention

According to one or more aspects, an automated driving assistance apparatus, an automated driving assistance system, and an automated driving assistance method that enable a driver to promptly cope with manual driving when switching from automated driving to manual driving can be provided.

### BRIEF DESCRIPTION OF THE DRAWINGS

FIG. 1 is a diagram illustrating a switching zone, a control execution zone, a checkpoint, and the like that are set on a highway on which a switch from automated driving to manual driving is made by an automated driving assistance apparatus according to one or more embodiments.

FIG. 2 is a control block diagram illustrating the configuration of an automated driving assistance apparatus and an automated driving assistance system according to one or more embodiments.

FIG. 3 is a diagram illustrating preparation items required for manual driving that are notified to a driver, in an automated driving assistance apparatus, such as in FIG. 2.

FIG. 4 is a flowchart illustrating operations of an automated driving assistance apparatus, such as in FIG. 2.

### EMBODIMENTS OF THE INVENTION

Embodiments will be described below with reference to the drawings.

### Embodiments

### Configuration

An automated driving assistance apparatus 10 of one or more embodiments, an automated driving assistance system 50 provided with the automated driving assistance apparatus 10, and an automated driving assistance method will be described.

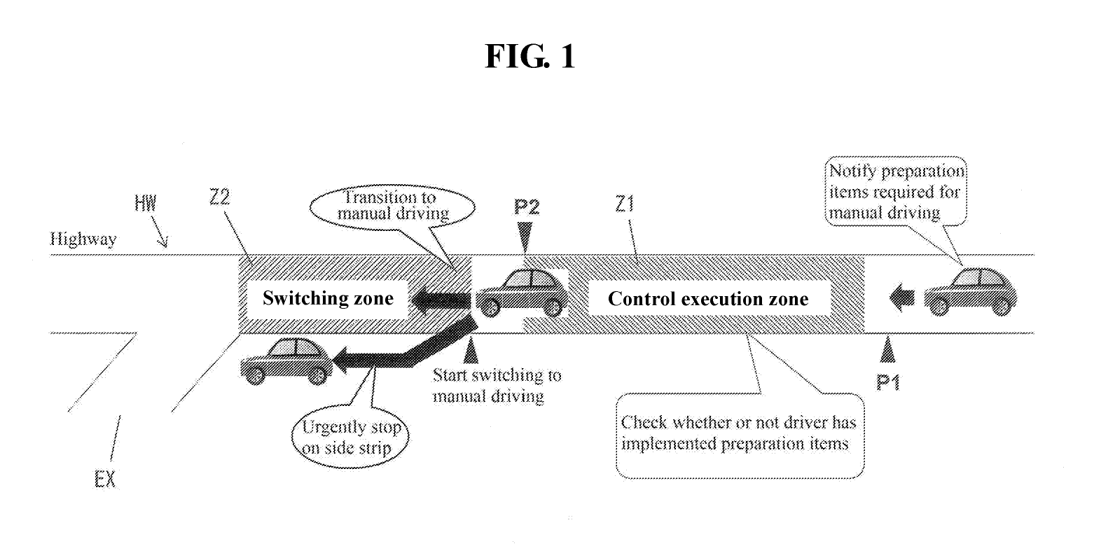

The automated driving assistance system 50 according to one or more embodiments notifies the driver of preparation items required for manual driving before switching a passenger car 20 that is traveling on a highway HW from automated driving to manual driving through automated driving control as shown in FIG. 1, for example. More specifically, the automated driving assistance system 50 of one or more embodiments notifies the driver of preparation items at a checkpoint P1 that has been set on the highway HW, and whether or not the preparation items have been implemented by the driver is checked in a control execution zone Z1. If the preparation items have been implemented before a re-check point P2, the automated driving assistance system 50 makes a switch from automated driving to manual driving in a switching zone Z2. On the other hand, if the preparation items have not been implemented before the re-check point P2 is reached, the automated driving assistance system 50 stops the passenger car 20 urgently.

In one or more embodiments, the control execution zone Z1 and the switching zone

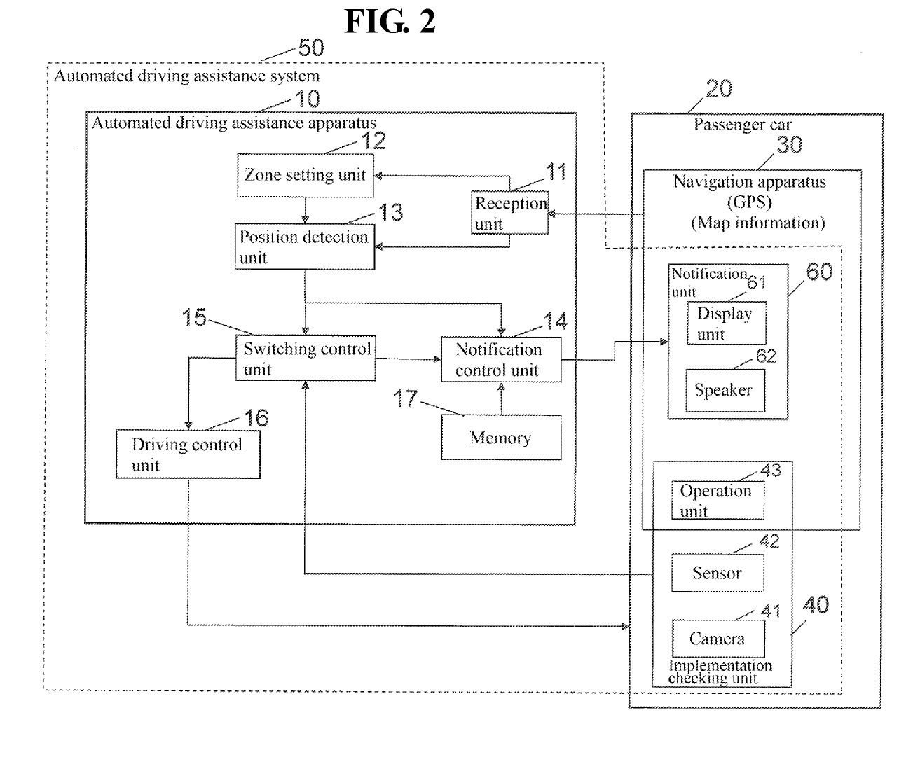

Z2 are set based on information regarding a destination that has been input to a navigation apparatus 30 mounted in the passenger car 20 and an interchange (IC) closest to the destination, map information, current position information of the passenger car 20 that is obtained using a GPS (Global Positioning System) as shown in FIG. 2 to be described later.

Here, the above control execution zone Z1 refers to a zone having a length of several kilometers in which assistance control of a switch to manual driving is performed. The control execution zone Z1 is set at a point that is several kilometers before the switching zone Z2 that has been set from destination information. The checkpoint P1 is set at a position immediately before the passenger car 20 moves into the control execution zone Z1. When the passenger car 20 reaches the checkpoint P1, notification of preparation items that are to be implemented in the control execution zone Z1 is started. Note that the checkpoint P1 is arranged immediately before the control execution zone Z1, but the checkpoint P1 may be provided at a position of the end of the control execution zone Z1 on the opposite side to the advancing direction of the passenger car 20.

The above switching zone Z2 refers to a zone having a length of several kilometers that is set between the above control execution zone Z1 and an IC exit EX, and in which control of switching from automated driving to manual driving is performed. The switching zone Z2 is set at a position that is several kilometers before the IC exit EX that is set from destination information.

Additionally, the re-check point P2 is set at a position immediately before the passenger car 20 moves into the switching zone Z2. The re-check point P2 is a point at which it is determined that a switch to manual driving cannot be made in the switching zone Z2 if the preparation items have not been implemented at this point.

The re-check point P2 coincides with the end of the control execution zone Z1 on the advancing direction side of the passenger car 20. This is because checking of the preparation items is performed before the passenger car 20 reaches the re-check point P2.

Note that the lengths of the control execution zone Z1 and the switching zone Z2 are adjusted according to the traveling speed of the road on which the passenger car 20 is traveling. For example, as in one or more embodiments, in the case of performing switch control on the highway HW, the traveling speed during automated driving control is estimated as 80 to 100 km/h, and thus, the control execution zone Z1 and the switching zone Z2 are set to have a length of 1 to 3 km, for example.

On the other hand, in the case of performing switch control on a public road, the traveling speed during automated driving control is estimated to be 30 to 60 km/h, and thus, the control execution zone Z1 and the switching zone Z2 are set to have a length of several hundred meters to 1 km, for example.

Automated Driving Assistance System 50

The automated driving assistance system 50 of one or more embodiments is a system for assisting automated driving of a passenger car, and includes an automated driving assistance apparatus 10, a notification unit 60, and an implementation checking unit 40.

When switching from automated driving to manual driving, the automated driving assistance apparatus 10 controls the notification unit 60 to notify the driver of preparation items required for manual driving, and in the case where the implementation checking unit 40 confirms that the preparation items have been implemented, performs control so as to switch from manual driving to automated driving.

Notification Unit 60

The notification unit 60 includes a display unit 61 and a speaker 62 as shown in FIG. 2, for example. In one or more embodiments, the display unit 61 and the speaker 62 are shared with the navigation apparatus 30. Specifically, the automated driving assistance system 50 uses the display unit 61 and the speaker 62 provided in the navigation apparatus 30. The display unit 61 is a liquid crystal display or the like.

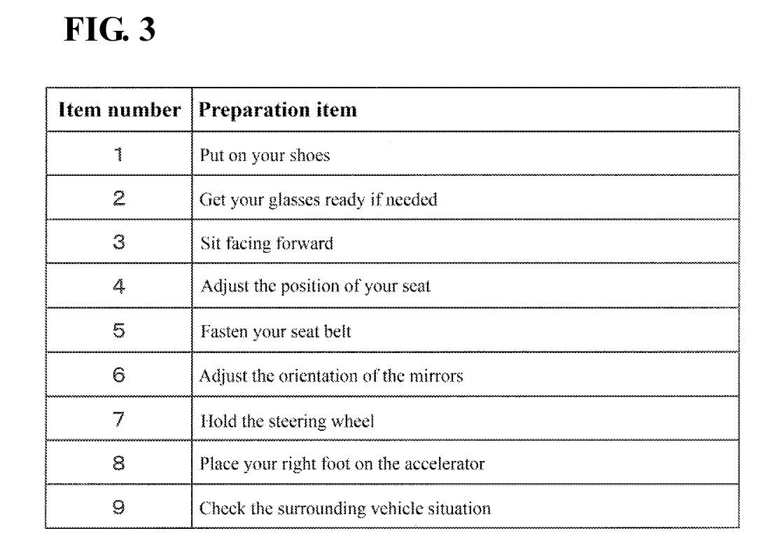

Driver's preparation items required for performing manual driving when switching from automated driving to manual driving are displayed on the display unit 61. FIG. 3 is a diagram showing a display example of the preparation items. In FIG. 3, implementation checking of the driver wearing shoes is displayed as a first preparation item, and, specifically, a message “Put on your shoes” is displayed. Implementation checking of the driver wearing glasses is displayed as a second preparation item, and, specifically, a message “Get your glasses ready if needed” is displayed. Implementation checking of the driver sitting in a forward facing posture is displayed as a third preparation item, and, specifically, a message “Sit facing forward” is displayed. Implementation checking of the position adjustment of the driver's seat is displayed as a fourth preparation item, and, specifically, a message “Adjust the position of your seat” is displayed. Implementation checking of the wearing of a seat belt is displayed as a fifth preparation item, and, specifically, a message “Fasten your seat belt” is displayed. Position adjustment of the mirrors is displayed as a sixth preparation item, and, specifically, a message “Adjust the orientation of the mirrors” is displayed. Implementation checking of the holding of the steering wheel is displayed as a seventh preparation item, and, specifically, a message “Hold the steering wheel” is displayed. Implementation checking of placement of a foot on the accelerator is displayed as an eighth preparation item, and specifically, a message “Place your foot on the accelerator” is displayed. A check of the surrounding vehicle situation is displayed as a ninth preparation item, and, specifically, a message “Check the surrounding vehicle situation” is displayed.

In addition, the item numbers 1 to 9 shown in FIG. 3 are read out through the speaker 62 in order.

Execution Check Unit 40

The implementation checking unit 40 has a camera 41, a sensor 42, an operation unit 43, and the like as shown in FIG. 2, in order to perform implementation checking of the above preparation items.

The camera 41 can be arranged around the driver's seat, and, for example, can be mounted in front of the driver's seat above a portion in which the steering wheel is fixed, in order to capture the driver.

The sensor 42 is a sensor such as a pressure sensor, an infrared sensor, a position sensor (a linear sensor, an encoder, or a potentiometer), or the like.

The operation unit 43 is constituted by a touch panel, buttons, or the like provided on the navigation apparatus 30, for example. Implementation of the above-described preparation items may be confirmed by the driver operating the operation unit 43.

Implementation checking of the above-described preparation items will be described below in order.

Implementation checking of the driver wearing shoes in the item number 1 can be performed using the camera 41. The camera 41 is arranged at driver's feet, and whether or not shoes are being worn can be detected by analyzing an image captured by the camera 41. In addition, even in the case where the camera 41 is not provided at driver's feet, a configuration may be adopted in which learning is performed in advance based on an image of the driver wearing a plurality of shoes and an image of the driver not wearing a plurality of shoes, and whether or not the driver is currently wearing shoes is checked from a captured image based on the learning result.

In addition, wearing of shoes can be checked using an infrared sensor as an example of the sensor 42. The surface temperature changes between a state where shoes are worn and a state where shoes are not worn, and thus can be detected using an infrared sensor.

Implementation checking of the driver wearing glasses in the item number 2 can be performed by analyzing an image captured by the camera 41.

Implementation checking of the driver sitting in a forward facing posture in the item number 3 can be performed by analyzing an image captured by the camera 41.

Implementation checking of the position adjustment of the driver's seat in the item number 4 can be performed by analyzing an image captured by the camera 41. In addition, implementation checking of seat position adjustment can be performed by providing a position sensor on the seat.

Since wearing of a seat belt has been detected in vehicles in recent years, implementation checking of the wearing of a seat belt in the item number 5 can be performed by receiving a detection signal of such detection. In addition, implementation checking of the wearing of a seat belt may be performed by analyzing an image captured by the camera 41.

Checking of the position adjustment of mirrors in the item number 6 can be performed by receiving a signal from an opening/closing mechanism that has been provided in vehicles in recent years, regarding the side mirrors, for example. In addition, whether or not the rearview mirror is appropriately positioned can be checked by providing a position sensor or the like. Note that position adjustment of the side mirrors and the rearview mirror can be checked by analyzing a captured image of the camera 41.

Implementation checking of the holding of the steering wheel in the item number 7 can be performed by providing a pressure sensor on the steering wheel.

In addition, it is also possible to confirm that the steering wheel is being held, by analyzing a captured image of the camera 41.

Implementation checking of placing of a foot on the accelerator in the item number 8 can be performed by analyzing an image captured by the camera 41. In addition, implementation checking of the placement of a foot on the accelerator can also be performed by providing a sensor (a pressure sensor or a position sensor) on an accelerator pedal or the like.

A check of the surrounding vehicle situation in the item number 9 can be performed through an operation performed by the driver on the operation unit 43. For example, a checkbox or the like is displayed next to the item number 9, and after checking the surrounding situation, the driver can inform the implementation checking unit 40 that checking of the surrounding situation has been implemented, by touching the checkbox.

Note that, regarding the above item numbers 2 to 8, in the case of performing implementation checking using the camera 41, a configuration may be adopted in which learning is performed based on an image of a state where each item number has been implemented and an image of a state where the item number has not been implemented, and implementation checking is be performed from the current captured image based on the learning result, similar to description regarding the item number 1.

In addition, it is also possible to get the implementation checking unit 40 to recognize implementation of the item numbers 1 to 8 by an operation performed by the driver on the operation unit 43. However, detection using the camera 41, the sensor 42, and the like in combination with an operation by the driver is preferably performed, since objective determination can be made.

Automated Driving Assistance Apparatus 10

The automated driving assistance apparatus 10 includes a reception unit 11, a zone setting unit 12, a position detection unit 13, a notification control unit 14, a switching control unit 15, a driving control unit 16, and a memory 17.

The reception unit 11 is connected to the navigation apparatus 30 wirelessly or by cable, and receives information from the navigation apparatus 30. Information from the navigation apparatus 30 includes information regarding a destination that has been set by the driver or the like, map information, current location information, and the like. The reception unit 11 transmits information regarding a destination, map information, current location information, and the like to the zone setting unit 12, and transmits the current location information to the position detection unit 13.

The zone setting unit 12 sets the switching zone Z2 at a position that is several kilometers before the IC exit EX of the highway HW as shown in FIG. 1, based on destination information obtained from the navigation apparatus 30 of the passenger car 20 via the reception unit 11. The zone setting unit 12 also sets the control execution zone Z1 at a position that is several kilometers before the switching zone Z2 as shown in FIG. 1. The zone setting unit 12 also sets the end of the control execution zone Z1 on the switching zone Z2 side as the re-check point P2, and sets the checkpoint P1 a position before the control execution zone Z1.

Moreover, the zone setting unit 12 transmits the checkpoint P1, the control execution zone Z1, the re-check point P2, and the switching zone Z2 that have been set, to the position detection unit 13.

The position detection unit 13 detects that the passenger car 20 has reached the checkpoint P1, the control execution zone Z1, the re-check point P2 and the switching zone Z2, from the current position information of the passenger car 20 obtained via the reception unit 11, and the checkpoint P1, the control execution zone Z1, the re-check point P2 and the switching zone Z2 that have been set by the zone setting unit 12.

The notification control unit 14 controls the notification unit 60 that has the display unit 61, the speaker 62, and the like. Specifically, the notification control unit 14 controls the notification unit 60 to notify the driver of the preparation items required for manual driving shown in FIG. 3 by display or sound. Note that the notification control unit 14 and the notification unit 60 are connected by cable or wirelessly.

The switching control unit 15 performs control regarding a switch from automated driving to manual driving, based on information regarding the vehicle having reached the re-check point P2, which has been received from the position detection unit 13, and implementation checking of the preparation items performed by the implementation checking unit 40, and gives instructions to the driving control unit 16.

The driving control unit 16 controls driving of the passenger car 20. Specifically, the driving control unit 16 performs automated driving of the passenger car 20, and also makes a switch from automated driving to manual driving by cancelling automated driving based on an instruction from the switching control unit 15. Furthermore, the driving control unit 16 also performs control so as to automatically stop the passenger car 20 based on an instruction from the switching control unit 15.

The memory 17 stores contents of the preparation items that are to be notified by the notification unit 60 to the driver under control of the notification control unit 14.

Operations

Operations of the automated driving assistance apparatus 10 of one or more embodiments will be described below, and an example of the automated driving assistance method of one or more embodiments will also be described below.

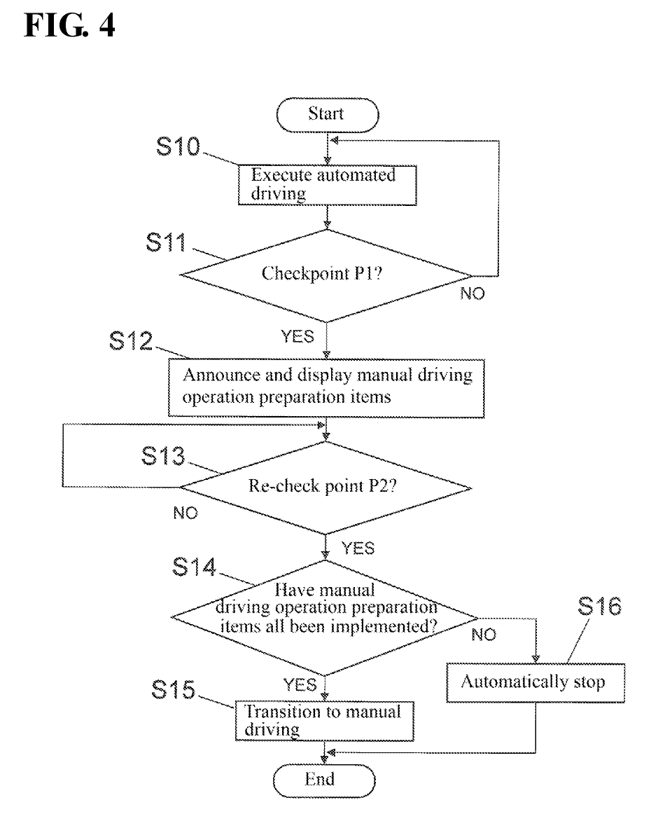

In step S10 in FIG. 4, automated driving of the passenger car 20 is executed. In other words, automated driving control of the passenger car 20 is executed by the driving control unit 16.

Next, in step S11, the position detection unit 13 detects that the passenger car 20 has reached the checkpoint P1. Specifically, the position detection unit 13 detects that the passenger car 20 has reached the checkpoint P1, from the current position of the vehicle that is obtained via the reception unit 11, and the position of the checkpoint P1 that has been set by the zone setting unit 12. Step S11 corresponds to an example of the detecting of a first position.

When it is detected in step S11 that the passenger car 20 has reached the checkpoint P1, the driver is notified of preparation items required for the operation of manual driving in step S12.

Specifically, upon receiving, from the position detection unit 13, information regarding the passenger car 20 having reached the checkpoint P1, the notification control unit 14 controls the display unit 61 such that the display unit 61 displays the preparation items required for the operation of manual driving, and causes the speaker 62 to make an announcement. Step S12 corresponds to an example of the notifying.

Next, in step S13, the position detection unit 13 detects whether or not the passenger car 20 has reached the re-check point P2. The position detection unit 13 detects whether or not the passenger car 20 has reached the re-check point P2, based on the current position obtained from the navigation apparatus 30 via the reception unit 11 and the re-check point P2 that has been set by the zone setting unit 12. Step S13 corresponds to an example of the detecting of a second position.

Subsequently, when it is detected in step S13 that the passenger car 20 has reached the re-check point P2, the switching control unit 15 determines in step S14 whether or not the implementation checking unit 40 has confirmed that all of the preparation items have been implemented. Step S14 corresponds to an example of implementation checking.

Specifically, in steps S12 to S14, the automated driving assistance apparatus 10 detects whether or not implementation checking for all of the preparation items is complete when the re-check point P2 is reached. Therefore, the re-check point P2 serves as an end point of the control execution zone Z1 in which notification to the driver and implementation checking are performed.

Note that, regarding notification and implementation checking of preparation items, a configuration may be adopted in which the preparation items are notified one by one, and after implementation of one preparation item is confirmed, another preparation item is notified, or a configuration may be adopted in which implementation checking is performed after all or some of preparation items are notified at the same time.

If it is confirmed in step S14 that all the preparation items have been implemented when the passenger car 20 reaches the re-check point P2, when the position detection unit 13 detects that the passenger car 20 has reached the switching zone Z2, the switching control unit 15 instructs the driving control unit 16 to switch from automated driving to manual driving in step S15. Subsequently, the driving control unit 16 controls driving of the passenger car 20 so as to switch from automated driving to manual driving.

In this manner, after the preparation items required for manual driving are notified to the driver in advance, and the driver having implemented the preparations is confirmed, transition from automated driving to manual driving is performed, and thus the driver can promptly cope with manual driving.

On the other hand, if implementation of all of the preparation items is not confirmed in step S14 when the re-check point P2 is reached, the switching control unit 15 instructs the driving control unit 16 to automatically stop the passenger car 20. For example, the driving control unit 16 urgently stops the passenger car 20 on a side strip as shown in FIG. 1.

Safety can be secured by urgently stopping the passenger car 20 if the preparation items have not been implemented, in this manner.

### Other Embodiments

One or more embodiments have been described above, but the invention is not limited to the above one or more embodiments, and various modifications can be made without departing from the gist of the invention.

(A)

In one or more embodiments, description has been given with an example in which a switch is made to manual driving while the passenger car 20 in automated driving is traveling on the highway HW. However, the invention is not limited thereto.

For example, the invention is not limited to a vehicle that is traveling on a highway, and one or more aspects may be applied as control when switching a vehicle that is traveling on a road other than a highway such as a public road, a vehicle-only road, or the like, to manual driving through automated driving control.

(B)

In one or more embodiments, description has been given with an example in which a switching zone for switching from automated driving to manual driving is set using information regarding a destination and an IC closest thereto that has been input via the navigation apparatus 30 mounted in the passenger car 20. However, the invention is not limited thereto.

For example, regarding setting of a switching zone, input of a destination is not necessary, and when it is detected that traffic congestion has occurred on a road on which a vehicle is traveling, a switching zone for switching from automated driving to manual driving may be automatically set before the traffic congestion zone.

In addition, for example, on a road or the like on which traffic congestion frequently occurs, a switching zone may be set in advance in order to switch from automated driving to manual driving before a point at which traffic congestion occurs. In this case, checking before entering a control execution zone and re-checking before entering the switching zone may be performed using communication between a communication apparatus mounted in the passenger car and communication apparatuses or the like installed on the road side of the checkpoint P1 and the re-check point P2 (an example of the first position detection unit and an example of the second position detection unit).

(C)

In one or more embodiments, both detection of the checkpoint P1 and detection of the re-check point P2 are performed by the position detection unit 13, but detection of the checkpoint P1 and detection of the re-check point P2 may be performed by different detection units. In addition, also in the case of using communication apparatuses as examples of the first position detection unit and the second position detection unit as described above, communication with the checkpoint P1 and communication with the re-check point P2 may be performed by different communication apparatuses.

(D)

In one or more embodiments, description has been given with an example in which, in the case where implementation of all of the preparation items is not complete when the passenger car 20 reaches the re-check point P2, the vehicle is automatically stopped on a side strip of the road on which the vehicle is traveling. However, the invention is not limited thereto, and for example, in the case where a passenger car is traveling on a highway, a parking area, a service area or the like may be set as a shelter area in which the vehicle is automatically stopped. In addition, in the case where a passenger car is traveling on a public road, the passenger car may be automatically stopped in a parking lot such as a coin parking lot instead of a side strip.

In this manner, in the case where a passenger car is not urgently stopped on a side strip, automated driving is performed continuously without switching to manual driving in the switching zone Z2, and automated driving continues to a shelter position such as a parking area.

(E)

In one or more embodiments, description was given with an example in which, in the case where implementation of all of the preparation items is not complete when the passenger car 20 reaches the re-check point P2, the passenger car 20 is automatically stopped on a side strip of the road on which the passenger car 20 is traveling, but automated driving may be performed until the next exit of the IC without stopping the passenger car 20. In this case, the control execution zone Z1 and the switching zone Z2 may be provided at the next exit of the IC.

(F)

Note that, in one or more embodiments, description was given in which the operation unit 43 may be operated to cause the implementation checking unit 40 to recognize that the driver has implemented the preparation items, but there is no limitation to an operation of the operation unit 43, and a spoken reply, a gesture, or the like may be used. In the case of a spoken reply, the voice of the driver is recognized by speech recognition, and in the case of a gesture, checking of implementation by the driver can be recognized by image analysis.

(G)

In one or more embodiments, a description was given with an example in which the automated driving assistance apparatus 10 is mounted in the passenger car 20 as an example of a vehicle. However, examples of the vehicle may include other vehicles to which the application of automated driving is envisioned, such as trains, buses, ships, and work vehicles, in addition to a passenger car.

(H)

The automated driving assistance apparatus 10 and the automated driving assistance system 50 of one or more embodiments use the navigation apparatus 30 mounted in the passenger car 20, but the automated driving assistance apparatus 10 and the automated driving assistance system 50 may have a storage unit that stores map information, a detection unit that detects the current position information, a setting unit that sets a destination, a route search unit that searches for a route to the destination, the implementation checking unit 40, the notification unit 60, and the like, without using the navigation apparatus 30.

(I)

In one or more embodiments, as the automated driving assistance method, a method that is executed in accordance with the flowchart shown in FIG. 4 has been described as an example. However, the invention is not limited thereto.

For example, one or more aspects may be realized as a program for causing a computer to execute the automated driving assistance method that is executed in accordance with the flowchart shown in FIG. 4

In addition, as a utility form of the program, one or more aspects may be adopted in which the program is stored in a computer-readable recording medium such as a ROM, and operates in cooperation with a computer.

In addition, as a utility form of the program, one or more aspects may be adopted in which the program is transmitted through a transmission medium such as the Internet, or a transmission medium such as light, radio waves, or sound waves, is read by a computer, and operates in cooperation with the computer.

### INDUSTRIAL APPLICABILITY

The automated driving assistance apparatus, the automated driving assistance system, and the automated driving assistance method provide an effect of allowing the driver to promptly cope with manual driving when switching from automated driving to manual driving, and can be widely applied to various apparatuses that assist automated driving.

### INDEX TO THE REFERENCE NUMERALS

10 Automated driving assistance apparatus
11 Reception unit
12 Zone setting unit
13 Position detection unit (an example of a first position detection unit and an example of a second position detection unit)
14 Notification control unit
15 Switching control unit
16 Driving control unit (an example of an automatic stop control unit)
17 Memory
20 Passenger car (an example of a vehicle)
30 Navigation apparatus
40 Implementation checking unit
41 Camera
42 Sensor
43 Operation unit
50 Automated driving assistance system
60 Notification unit
61 Display unit
62 Speaker
EX IC exit
HW Highway
P1 Check point (an example of a first position)
P2 Re-check point (an example of a second position)
Z1 Control execution zone
Z2 Switching zone

1. An automated driving assistance apparatus for assisting automated driving of a vehicle, comprising:
a first position detection unit configured to detect a first position that is before, in an advancing direction, a switching zone in which a switch is made from the automated driving to manual driving; and
a notification control unit configured to control a notification unit to notify a driver of a preparation item required for manual driving when switching from the automated driving to the manual driving, when the first position detection unit detects that the vehicle has reached the first position.

2. The automated driving assistance apparatus according to claim 1, further comprising:
a switching control unit configured to perform control regarding a switch from the automated driving to the manual driving in the switching zone, based on a check by an implementation checking unit that checks whether or not the preparation item has been implemented.

3. The automated driving assistance apparatus according to claim 2, further comprising:
a second position detection unit configured to detect a second position provided between the first position and the switching zone,
wherein the switching control unit does not make a switch from the automated driving to the manual driving in a case where the implementation checking unit has not confirmed that the preparation item has been implemented when the second position detection unit detects that the vehicle has reached the second position.

4. The automated driving assistance apparatus according to claim 3, further comprising:
an automatic stop control unit configured to automatically stop the vehicle in a shelter area in a case where the implementation checking unit has not confirmed that the preparation item has been implemented when the second position detection unit detects that the vehicle has reached the second position.

5. The automated driving assistance apparatus according to claim 1,
wherein the notification unit is a display or a speaker.

6. The automated driving assistance apparatus according to claim 1,
wherein the preparation items include wearing of shoes, a forward facing sitting posture, seat position adjustment, wearing of a seat belt, position adjustment of a side mirror or a rearview mirror, holding of a steering wheel, placing of a foot on an accelerator pedal, or a check of a surrounding vehicle situation.

7. The automated driving assistance apparatus according to claim 2,
wherein the implementation checking unit includes a camera or a sensor.

8. An automated driving assistance system for assisting automated driving of a vehicle, the system comprising:
a first position detection unit configured to detect a first position that is before, in an advancing direction, a switching zone in which a switch is made from the automated driving to manual driving;
a notification unit configured to notify a driver of a preparation item required for manual driving when switching from the automated driving to the manual driving; and
a notification control unit configured to control the notification unit to perform the notification when the first position detection unit detects that the vehicle has reached the first position.

9. An automated driving assistance method for assisting automated driving of a vehicle, the method comprising:
detecting a first position that is before, in an advancing direction, a switching zone in which a switch is made from the automated driving to manual driving; and
notifying a driver of a preparation item required for manual driving when switching from the automated driving to the manual driving, when it is detected in the detecting that the vehicle has reached the first position.

10. A non-transitory computer-readable recording medium storing a program for assisting automated driving of a vehicle, the program causing a computer to perform operations comprising:
detecting a first position that is before, in an advancing direction, a switching zone in which a switch is made from the automated driving to manual driving; and
notifying a driver of a preparation item required for manual driving when switching from the automated driving to the manual driving, when it is detected in the detecting that the vehicle has reached the first position.
